(19) United States
(12) Patent Application Publication
(10) Pub. No.: US 2026/0338983 A1
(43) Pub. Date: Oct. 29, 2026

(54) SUBSURFACE RANGING SYSTEMS AND METHODS USING FLOW-TRANSPORTABLE MAGNETIC AND/OR NONMAGNETIC METALLIC MATERIALS

(71) Applicant: BP Exploration Operating Company Limited, Middlesex (GB)

(72) Inventors: Shivnandan Pingle, Middlesex (GB); Joseph Wee, West Chiltern (GB); Nick Cameron, Middlesex (GB); William Allen, Powell, WY (US)

(73) Assignee: BP Exploration Operating Company Limited, Middlesex (GB)

(21) Appl. No.: 19/660,366

(22) Filed: Apr. 28, 2026

Related U.S. Application Data
(60) Provisional application No. 63/795,704, filed on Apr. 28, 2025.

(51) Int. Cl. G01V 3/08; G01V 3/26

(52) U.S. Cl. CPC G01V 3/081; G01V 3/26

(57) ABSTRACT

A method for estimating a subsurface location of a target wellbore includes positioning a flow transportable magnetic or nonmagnetic metallic material through a target wellbore extending through a subsurface region and into an openhole section of the target wellbore, applying an excitation signal to the magnetic or nonmagnetic metallic material located in the openhole section of the target wellbore, receiving by an electromagnetic ranging sensor an electromagnetic subsurface signal produced in response to the application of the excitation signal to the magnetic or nonmagnetic metallic material, and estimating a subsurface location of the openhole section of the target wellbore using the electromagnetic subsurface signal received by the electromagnetic ranging sensor.

### CROSS-REFERENCE TO RELATED APPLICATIONS

The present application claims benefit of U.S. provisional patent application No. 63/795,704 filed Apr. 28, 2025, and entitled “Subsurface Ranging Systems and Methods Using Flow-Transportable Magnetic and/or Nonmagnetic Metallic Materials”

### BACKGROUND

Drilling multiple wellbores in close proximity through a subsurface region is a common strategy across various applications including, oil, gas, geothermal, and thermal recovery operations (such as Steam Assisted Gravity Drainage, or SAGD). For instance, in oil and gas operations, forming multiple wellbores in close proximity may maximize reservoir contact, improve resource recovery efficiency, and optimize production while minimizing surface footprint. Typical applications include multilateral well systems where a single parent well branches into multiple laterals to access different reservoir zones, and infill drilling where additional wells are drilled within an existing pattern to enhance sweep efficiency and accelerate hydrocarbon production. Moreover, in some applications a new well is drilled in proximity with a preexisting well with the intent of intercepting the preexisting well with the new well at a desired subsurface location. For instance, relief wells are drilled to intercept and control out-of-control or blowout wells to precisely establish a secure kill path. Wellbore abandonment and sidetracks further allow operators to bypass obstructions and resume production without initiating a new surface location. Additionally, in geothermal applications, multilateral and infill drilling strategies increase heat extraction from subsurface reservoirs and create dedicated injection and production well pairs in advanced geothermal systems (AGS) and enhanced geothermal systems (EGS). Further, thermal recovery applications such as SAGD rely on precisely drilled injector-producer well pairs to efficiently mobilize and recover hydrocarbons using steam heat. In order to facilitate the drilling of multiple wellbores in close proximity, a technique referred to as wellbore ranging is used to estimate a subsurface location of a target wellbore relative to an active wellbore using one or more ranging sensors.

### SUMMARY

An embodiment of a method for estimating a subsurface location of a target wellbore comprises (a) positioning a flow transportable magnetic or nonmagnetic metallic material through a target wellbore extending through a subsurface region and into an openhole section of the target wellbore, (b) applying an excitation signal to the magnetic or nonmagnetic metallic material located in the openhole section of the target wellbore, (c) receiving by an electromagnetic ranging sensor an electromagnetic subsurface signal produced in response to the application of the excitation signal to the magnetic or nonmagnetic metallic material, and (d) estimating a subsurface location of the openhole section of the target wellbore using the electromagnetic subsurface signal received by the electromagnetic ranging sensor. In some embodiments, the magnetic or nonmagnetic metallic material comprises at least one of a magnetic plug and a magnetic packer. In some embodiments, the magnetic or nonmagnetic metallic material comprises a ferrofluid. In certain embodiments, the magnetic or nonmagnetic metallic material comprises a magneto-rheological (MR) fluid. In certain embodiments, the magnetic or nonmagnetic metallic material comprises a drilling fluid including a plurality of magnetic or nonmagnetic metallic particles. In some embodiments, the MR fluid comprises a carrier liquid and a plurality of magnetic particles settled from the carrier liquid and lining a sidewall and/or a toe end of the target wellbore. In some embodiments, the magnetic or nonmagnetic metallic material comprises a filter cake at least partially lining a sidewall of the target wellbore, the filter cake comprising a plurality of magnetic or nonmagnetic metallic particles. In certain embodiments, (b) comprises inducing an electrical current and/or a radio frequency energy in the subsurface region. In certain embodiments, (b) comprises inducing an external magnetic field in the subsurface region. In some embodiments, (b) comprises inducing the excitation signal by an excitation sub located in an active wellbore extending through the subsurface region that is different from the target wellbore. In some embodiments, (b) comprises inducing the excitation signal by an excitation sub located at a surface of the target wellbore. In certain embodiments, the electromagnetic subsurface signal comprises an electrical resistivity subsurface signal.

An embodiment of a method for estimating a subsurface location of a target wellbore comprises (a) positioning a fluid containing a plurality of magnetic or nonmagnetic metallic particles into a target wellbore extending through a subsurface region, (b) applying an excitation signal to the magnetic or nonmagnetic metallic particles located in the target wellbore, (c) receiving by an electromagnetic ranging sensor an electromagnetic subsurface signal produced in response to the application of the excitation signal to the magnetic or nonmagnetic metallic particles, and (d) estimating a subsurface location of the target wellbore using the electromagnetic subsurface signal received by the electromagnetic ranging sensor. In certain embodiments, the fluid comprises a ferrofluid. In some embodiments, the fluid comprises a magneto-rheological (MR) fluid. In some embodiments, a plurality of magnetic particles of the MR fluid form a continuous, electrically conductive path lining a sidewall and/or a toe end of the target wellbore. In certain embodiments, the fluid forms a filter cake at least partially lining a sidewall of the target wellbore, the filter cake comprising the magnetic or nonmagnetic metallic particles. In certain embodiments, (b) comprises inducing the excitation signal by an excitation sub located in an active wellbore extending through the subsurface region that is different from the target wellbore. In some embodiments, (b) comprises inducing the excitation signal by an excitation sub located at a surface of the target wellbore. In certain embodiments, the fluid comprises a plurality of magnetic particles. In certain embodiments, the magnetic or nonmagnetic metallic particles each have a diameter that is equal to or less than 10 millimeters. In some embodiments, the magnetic or nonmagnetic metallic particles each have a diameter that is equal to or less than 100 nanometers.

An exemplary embodiment of a system for estimating a subsurface location of a target wellbore comprises a target wellbore extending through a subsurface region and which comprises a cased section and an openhole section, a flow transportable magnetic or nonmagnetic metallic material located in the openhole section of the target wellbore, an active wellbore extending through the subsurface region, an excitation sub configured to apply an excitation signal to the magnetic or nonmagnetic metallic material located in the openhole section of the target wellbore, an electromagnetic ranging sensor positioned in the active wellbore and which is configured to receive an electromagnetic subsurface signal produced in response to the application of the excitation signal to the magnetic or nonmagnetic metallic material, and a computer system comprising one or more processors and a storage device coupled to the one or more processors, the storage device configured to store instructions that, when executed by the one or more processors, configure the one or more processors to estimate a subsurface location of the openhole section of the target wellbore using the electromagnetic subsurface signal received by the electromagnetic ranging sensor.

### BRIEF DESCRIPTION OF THE DRAWINGS

For a detailed description of various exemplary embodiments, reference will now be made to the accompanying drawings in which:

FIGS. 1 and 2 are perspective views of an embodiment of a system for estimating a position or ranging a target wellbore extending through a subsurface region in accordance with principles disclosed herein;

FIGS. 3-6 are schematic views of exemplary magnetic materials in accordance with principles disclosed herein;

FIG. 7 is a perspective view of another embodiment of a system for estimating a position or ranging a target wellbore extending through a subsurface region in accordance with principles disclosed herein;

FIG. 8 is a block diagram of an embodiment of a computer system in accordance with principles disclosed herein; and

FIGS. 9 and 10 are flowcharts of embodiments of methods for estimating a subsurface location of a target wellbore in accordance with principles disclosed herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, in various applications it may be desirable to drill and place a plurality of separate wellbores in proximity. In some instances, challenges arise with avoiding unintentionally intercepting preexisting wellbores when drilling a new, active wellbore while in other instances challenges arise with intercepting a preexisting target wellbore with a newly drilled relief wellbore precisely at a desired subsurface location. Particularly, proximity of multiple wellbores introduces the risk of mechanical interference between active and planned trajectories, which can result in stuck pipe, casing damage, or catastrophic blowouts. Effective collision avoidance requires continuous monitoring of wellbore positions and robust uncertainty modeling of the subsurface position of the active wellbore. Particularly, controlled intersection involves precisely targeting a specific wellbore (e.g., within a tolerance window of a few feet) to successfully connect two independent wellbores. This level of precision is critical for relief well operations, geothermal well pairs, and SAGD injector-producer well connections, ensuring safe well control, efficient heat exchange, and optimal resource recovery.

Conventionally, positioning such as measurement-while-drilling (MWD) sensors packaged within a bottomhole assembly (BHA) of an active wellbore are utilized to estimate a subsurface position of the BHA and terminal or toe end of the active wellbore. For example, the BHA may include sensors in the form of magnetometers, gyroscopes, and accelerometers that leverage the Earth's magnetic and gravitational fields to monitor an orientation and position of the BHA via dead-reckoning. Particularly, the BHA may be located in an active wellbore whereby a relative position between the active wellbore and a “target” wellbore may be estimated.

Ranging sensors may comprise, among others, magnetic ranging sensors, electrical resistivity sensors, acoustic ranging sensors, electrical resistivity ranging sensors, seismic ranging sensors, and fiber optic ranging sensors. Ranging systems are also typically classified as either being passive or active in nature. Generally, passive ranging systems generally passively “listen” or capture information from the subsurface environment (e.g., magnetic interference from ferromagnetic objects such as a casing string located in the target wellbore) whereas active ranging systems detect signals generated by a corresponding signal transmitter often located in a separate wellbore. Thus, active ranging sensors rely on the injection of a synthetic signal into the subsurface region by a signal transmitter while passive ranging sensors do not similarly rely on the injection of a synthetic signal into the subsurface region.

Magnetic ranging sensors, along with detecting the magnetic disturbance passively generated by the presence of ferromagnetic objects, may also utilize the injection of an electrical current or time-varying magnetic field (e.g., produced by a rotating magnet and the like) in order to produce an magnetic subsurface signal that may be captured by a suitable magnetic ranging sensor. Further ranging systems employing magnetic ranging sensors may be classified as either access dependent or access independent. Generally, access dependent ranging systems require direct access to a target wellbore for successful operation whereas access independent ranging systems do not similarly require direct access to the target wellbore for successful operation. As used herein, the term “direct access” with respect to a wellbore is defined as the ability to lower tools and/or circulate fluids through the wellbore. For instance, a wellbore having a surface rig or assembly having suitable equipment for running equipment (e.g., tubular strings, downhole tools) or circulating fluid (e.g., via a surface pump of the surface assembly) is provided with direct access while a wellbore that is not provided with a surface assembly that facilitates running equipment or circulating fluid through the wellbore is not provided with direct access.

Ranging systems may be access independent when estimating the subsurface location of a wellbore having downhole equipment previously installed therein. For instance, magnetic ranging sensors of an access independent ranging system may be provided in a BHA positioned in an active wellbore may estimate a relative position of a steel casing string forming a cased section of a target wellbore. For instance, the casing string may produce an electromagnetic subsurface signal (e.g., a magnetic subsurface signal, an electrical resistivity or conductivity subsurface signal) detectable by the magnetic ranging sensor particularly when the casing string is energized by an electrical current. While ranging systems may be access independent with respect to the cased sections of target wellbores, conventionally, ranging systems (including those using magnetic ranging sensors) are generally access dependent for uncased or “openhole” sections of target wellbores that do not similarly have a previously installed casing string (or similar preinstalled downhole equipment). Instead, direct access to the openhole section of the target wellbore may be required whereby downhole tools may be lowered therein to produce electromagnetic subsurface signals detectable by a ranging sensor located in an active wellbore. This requirement for direct access may not be feasible in some applications such as when the target wellbore has suffered a blowout or subsidence. Moreover, this requirement may require the use of a surface assembly at the target wellbore in addition to that provided for the active wellbore to provide direct access to the openhole section of the target wellbore, increasing the resources required for performing the ranging operation.

Accordingly, embodiments of ranging systems and methods are disclosed herein for estimating a subsurface location or “ranging” an openhole section of a wellbore using flow transportable magnetic materials or nonmagnetic metallic materials. As used herein, the term “flow transportable” with respect to magnetic and/or nonmagnetic metallic materials or other objects refers to materials that are transportable via a fluid flow circulating through the wellbore without being suspended, tethered, or otherwise mechanically connected to equipment at the surface. In other words, flow transportable magnetic and/or nonmagnetic metallic materials include magnetic and/or nonmagnetic metallic materials that may be freely pumped through the wellbore without being connected to any surface equipment. Magnetic and/or nonmagnetic metallic materials may include aggregate materials in the fluid flow and/or larger objects such as plugs and the like that are pumpable through the wellbore. In this manner, magnetic and/or nonmagnetic metallic materials may be deposited in the openhole section of a target wellbore whereby their position may be detected or estimated by electromagnetic ranging sensors (e.g., positioned in a separate, active wellbore) including, for example, magnetic ranging sensors and electrical resistivity ranging sensors. Additionally, as used herein, the term “magnetic materials” is defined as including substances whose internal atomic structure permits them to become strongly magnetized in the presence of an external magnetic field. In this manner, magnetic materials exhibit a high magnetic susceptibility (a dimensionless parameter corresponding to the ratio of magnetization to field strength) Magnetic materials include ferromagnetic alloys (iron, nickel, cobalt and their steels), ferromagnetic particles (e.g., carbonyl iron powder), and other magnetic particles including nanoscale magnetic particles such as magnetite, maghemite, and cobalt ferrite which distort Earth's ambient field and so can be detected and ranged by downhole magnetometers. Conversely, nonmagnetic metallic materials include electrically conductive metallic materials that are not magnetic materials such as, for example, aluminum and the like.

Embodiments of ranging systems described herein additionally include one or more excitation subs for applying excitation signals (e.g., electrical current that may be alternating current (AC) or direct current (DC), radio frequency (RF) energy or pulses, an external magnetic field) to the magnetic and/or nonmagnetic metallic materials located in the target wellbore. The application of the excitation signal may alter one or more electromagnetic parameters of the magnetic and/or nonmagnetic metallic materials present in the target wellbore. For example, the excitation signal may alter an orientation of the magnetic poles (e.g., along a single direction) of the materials. Additionally, embodiments disclosed herein include one or more electromagnetic ranging sensors configured to detect electromagnetic subsurface signals produced in response to the application of the excitation signals to the magnetic and/or nonmagnetic metallic materials. For instance, in some embodiments, the electromagnetic subsurface signals comprise magnetic subsurface signals corresponding to local disturbances in Earth's natural magnetic field that are correlated with the subsurface location of magnetic materials positioned in the target wellbore. In certain embodiments, the electromagnetic subsurface signals may comprise electrical conductivity or resistivity subsurface signals corresponding to an electrical resistance of the materials. Embodiments disclosed herein may estimate a subsurface position of the magnetic and/or nonmagnetic metallic materials, and hence the openhole section of the target wellbore in which they are positioned, using the received electromagnetic subsurface signals. This subsurface location may be relative to an active wellbore in which one or more electromagnetic ranging sensors are positioned.

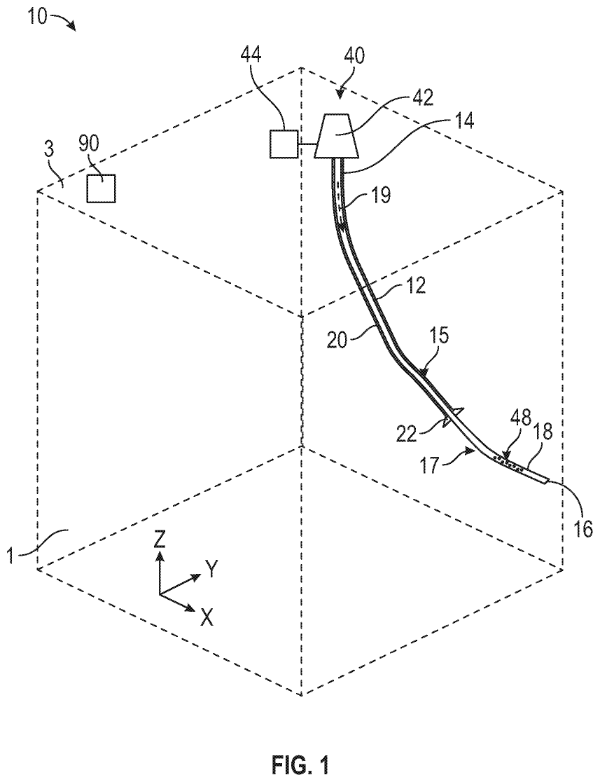

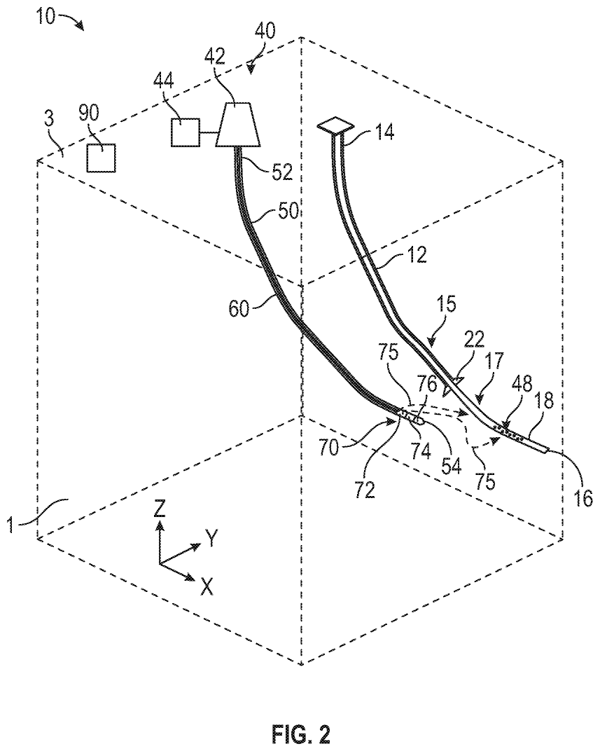

Referring initially to FIGS. 1 and 2, an embodiment of a system 10 for estimating a position or ranging a target wellbore extending through a subsurface region 1 is shown. In this exemplary embodiment, ranging system 10 generally includes one or more target wellbores 12, a surface rig or assembly 40, one or more active wellbores 50, and a surface computer system 90. Target wellbore 12 of ranging system 10 may be drilled into the subsurface region 1 for a variety of purposes. For instance, target wellbore 12 may perform various functions such as injection (e.g., steam injection), production (e.g., hydrocarbons, geothermally heated fluid), closed-loop geothermal applications, and other functions. Target wellbore 12 extends between a first or uphole end 14 located at the (e.g., terranean) surface 3 (e.g., an onshore surface for onshore wellbores or a seabed for offshore wellbores) and a longitudinally opposed second or toe end 16 located vertically (along the “Z” direction in FIG. 1) beneath the surface 3 within the subsurface region 1. The configuration including the size, shape, trajectory, depth, diameter, and other parameters of wellbore 12 may vary from that shown in FIG. 1 in other embodiments. Moreover, the number of guide wellbores 12 may also vary from that shown in FIG. 1 in other embodiments. For instance, in other embodiments, ranging system 10 may include more than a single target wellbore 12.

In this exemplary embodiment, a casing string 20 is positioned in the target wellbore 12 and extends from the uphole end 14 thereof to a casing shoe 22 located within subsurface region 1 but spaced from the toe end 16 of target wellbore 12. Casing string 20 may comprise a plurality of steel casing joints connected end-to-end and installed in the target wellbore 12 using the surface assembly 40. Casing string 20 may be secured to a sidewall 18 of the target wellbore 12 via cement that is pumped as a slurry into target wellbore 12 by the surface assembly 40. Additionally, casing string 20 divides target wellbore 12 between a cased section 15 extending longitudinally from the uphole end 14 thereof to the casing shoe 22 of casing string 20, and a separate uncased or openhole section 17 of the target wellbore 12 that extends longitudinally between the casing shoe 22 of casing string 20 and the toe end 16 of target wellbore 12.

Ranging system 10 is shown in an initial or deployment configuration in FIG. 1 and a second or ranging configuration in FIG. 2. In the deployment configuration, the surface assembly 40 is located at the uphole end 14 of target wellbore 12 thus providing direct access to target wellbore 12 whereby downhole tools, equipment, and/or fluids may be inserted or circulated through the target wellbore 12 from the uphole end 14 thereof. In this exemplary embodiment, surface assembly includes a surface rig 42 and a surface pumping system 44 including one or more surface pumps. Surface rig 42 may include a support structure (e.g., a derrick or drilling rig), well control equipment such as one or more blowout preventers (BOP), a top drive or rotary system for running equipment (e.g., tubular strings, downhole tools) into the target wellbore 12, and/or other equipment for facilitating direct access to the target wellbore 12.

In this exemplary embodiment, the surface pump system 44 of surface assembly 40 is configured to produce a fluid flow 19 carrying magnetic and/or nonmagnetic metallic materials 48 from the uphole end 14 of target wellbore 12, through the cased section 15 of target wellbore 12, and into the openhole section 17 thereof. Particularly, surface pump system 44 may pump a variety of fluids through the target wellbore 12 including fluids containing flow-transportable magnetic and/or nonmagnetic metallic materials 48 to deliver said magnetic and/or nonmagnetic metallic materials 48 to the openhole section 17 of target wellbore 12. The magnetic and/or nonmagnetic metallic materials 48 may be suspended within the fluid flow 19 or may be separate from the fluid flow 19 and pumped by the fluid flow 19 through the target wellbore 12. In some embodiments, surface pump system 44 may be operated to recover the magnetic and/or nonmagnetic metallic materials 48 from the target wellbore 12 following completion of the ranging operation.

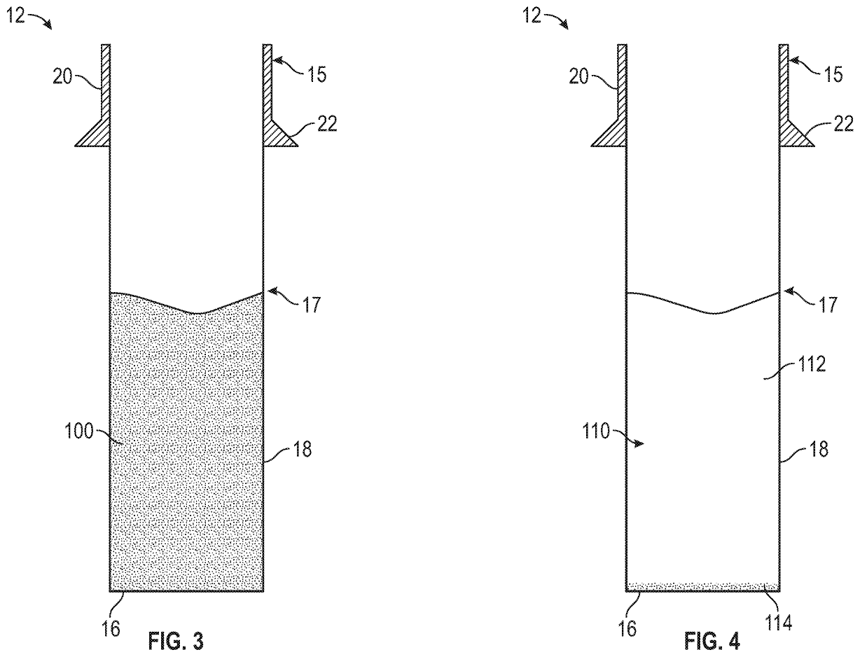

Referring now to FIGS. 3-6, different examples of magnetic and nonmagnetic metallic materials pumpable into the openhole section 17 of target wellbore 12 by surface pump system 44 are shown. Particularly, FIG. 3 illustrates magnetic materials in the form of a ferrofluid 100. Ferrofluid 100 comprises a liquid carrier which a plurality of nanoscale magnetic particles (e.g., less than 100 nanometers (nm) in diameter) that are suspended to form a colloidal suspension. The magnetic particles of the ferrofluid 100 may remain in suspension even when the ferrofluid is stationary due to Brownian motion.

In some embodiments, the ferrofluid 100 includes a surfactant that prevents the magnetic particles thereof from clumping together during use. For instance, the surfactant may coat the magnetic particles to ensure they remain dispersed in the carrier liquid to prevent agglomeration due to magnetic, Van der Waals, or other forces. Additionally, in certain embodiments, the volume fraction of iron oxide (e.g., magnetite, Fe3O4) magnetic particles ranges approximately between 1% and 30% of the total volume of the ferrofluid 100 with the remaining volume being the carrier liquid and surfactant. Further, in certain embodiments, the magnetic susceptibility of the ferrofluid 100 ranges approximately between 10 and 300. However, the magnetic susceptibility of ferrofluid 100 may vary substantially based on the concentration of magnetic particles and other factors.

Not intending to be bound by any particular theory, unlike ferromagnetic materials that retain magnetization even when an external magnetic field is removed, ferrofluid 100 exhibits superparamagnetism in which the magnetic moments of the magnetic particles of the ferrofluid 100 align when an external magnetic field is applied but randomize immediately after the external magnetic field is removed due to thermal energy and thus do not retain their magnetization following removal of the external magnetic field. Particularly, in the absence of an external magnetic field, thermal energy of the magnetic particles may exceed the magnetic dipole interaction energy whereby the magnetic particles remain suspended randomly in the base liquid due to Brownian motion and the ferrofluid 100 has no net magnetization. However, in response to the application of an external magnetic field, the dipole interaction energy of the magnetic particles increases to overcome the thermal energy whereby the magnetic particles orient along the direction of the external magnetic field to form chain-like structures until saturation magnetization is achieved.

FIG. 4 illustrates magnetic materials in the form of magneto-rheological (MR) fluid 110. MR fluid 110 comprises a base liquid 112 containing a plurality of magnetic particles 114. Magnetic particles 114 of MR fluid 110 may be larger than the magnetic particles of ferrofluid 100. For instance, magnetic particles 114 may be micrometer in scale such that, while magnetic particles 114 may remain suspended within base liquid 112 when MR fluid 110 is in motion, due to their size, magnetic particles 114 tend to settle out of the base liquid 112 over time when the MR fluid 110 is stationary as shown in FIG. 4. Thus, in some applications, the magnetic particles 114 of MR fluid 110 may settle along or against the toe end 16 of the target wellbore 12 rather than remaining suspended in the base liquid 112 at least partially filling the openhole section 17 of target wellbore 12. In other applications, the magnetic particles 114 may instead coat the “low” or vertically lower side of the sidewall 18 of the target wellbore 12 such as when the target wellbore 12 extends laterally through the subsurface region 1. Concentrating the location of magnetic particles 114 along the toe end 16 (or low side of the sidewall 18) may be advantageous in certain applications where it is particularly desirable to estimate or range the subsurface location of the toe end 16 of wellbore 12 relative to an active wellbore. For instance, it may be desirable to locate the toe end 16 of target wellbore 12 in applications where it is desired to intercept (e.g., by the active wellbore) the target wellbore 12 at the toe end 16 thereof.

FIG. 5 illustrates magnetic and/or nonmagnetic metallic materials in the form of a magnetic or nonmagnetic metallic filter cake 120 lining the sidewall 18 of the target wellbore 12. Filter cake 120 may be positioned along or define the sidewall 18 of target wellbore 12 during the drilling of target wellbore 12. Particularly, drilling fluid discharged from a drill bit engaging the toe end 16 of target wellbore 12 is circulated to the uphole end 14 along the sidewall 18 of target wellbore 12. As the drilling fluid circulates towards the uphole end 14 of target wellbore 12, some of the drilling fluid adheres to the sidewall 18 of target wellbore 12 forming the filter cake 120. In this example, the drilling fluid contains magnetic particles (e.g., ferromagnetic particles such as iron shavings and the like) suspended therein and thus are embedded (e.g., randomly dispersed) within the filter cake 120 and thus cover the sidewall 18 of wellbore 12. In this arrangement, the application of an external magnetic field to the filter cake 120 may produce a magnetic subsurface signal detectable by a electromagnetic ranging sensor positioned in a separate, active wellbore.

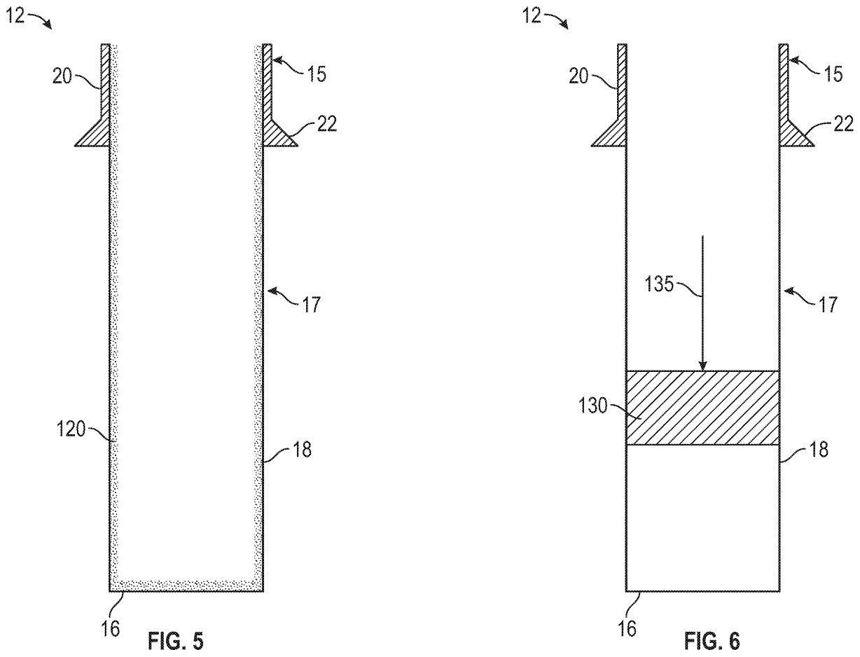

FIG. 6 illustrates magnetic and/or nonmagnetic metallic materials in the form of solid magnetic or nonmagnetic metallic packer or plug 130. Plug 130 may comprise one or more magnetic and/or nonmagnetic metallic materials such as ferromagnetic materials and nonmagnetic metallic materials (e.g., aluminum and the like). The size, shape, number, and configuration of plug 130 may vary depending on the needs of the given application. Additionally, rather than comprising a plurality of separate magnetic particles that are suspended in a carrier fluid, plug 130 may comprise a single magnetic or nonmagnetic metallic object that is pumped by a fluid (e.g., a drilling fluid or other fluid) from the uphole end 14, through target wellbore 12, until the plug 130 is received in the openhole section 17 of target wellbore 12. The fluid pumped from the uphole end 14 of target wellbore 12 applies a hydraulic or pumping force 135 to the plug 130 to force the plug 130 through the target wellbore 12. With plug 130 located in openhole section 17 of target wellbore 12, the application of an external electrical current and/or magnetic field to the plug 130 may produce an electromagnetic subsurface signal detectable by a electromagnetic ranging sensor positioned in a separate, active wellbore whereby the subsurface location of the plug 130 relative to the electromagnetic ranging sensor may be estimated.

Returning now to FIGS. 1 and 2, as described above, FIG. 2 illustrates ranging system 10 in the ranging configuration in which the surface assembly 40 has been moved from the target wellbore 12 to a second or active wellbore 50 to facilitate the drilling of the active wellbore 50 by providing direct access thereto. Thus, in the ranging configuration of ranging system 10, while direct access is provided by surface assembly 40 to the active wellbore 50, direct access is not provided to the target wellbore 12. In other embodiments, a second surface assembly 40 may incorporated into ranging system 10 to provide simultaneous direct access to both target wellbore 12 and active wellbore 50.

Active wellbore 50 extends between a first or uphole end 52 (e.g., positioned at an onshore surface or a seabed) located at the surface 3 and a longitudinally opposed second or toe end 54 located vertically beneath the surface 3 within the subsurface region 1. As with target wellbore 12, the size and/or shape of active wellbore 50, along with its respective number, may vary from that shown in FIG. 2.

Active wellbore 50 may perform various functions such as injection (e.g., steam injection), production (e.g., hydrocarbons, geothermally heated fluid), and other functions. In this exemplary embodiment, a drillstring 60 extends from the uphole end 52 of active wellbore 50, through the active wellbore 50 and towards the toe end 54 thereof. Drillstring 60 may include a central passage along which drilling fluid may be pumped from an uphole end of drillstring 60 at the surface 3 to a toe end thereof located proximal to the toe end 54 of active wellbore 50. In some embodiments, drillstring 60 comprises a plurality of tubular drill pipe joints that are connected (e.g., threadably) together end-to-end. In other embodiments, drillstring 60 comprises a continuous coiled tubing (CT) string rather than a plurality of separately connected drill pipe joints.

In this exemplary embodiment, a BHA 70 is coupled to a toe end of the drillstring 60 and is located at or proximal to the toe end 54 of active wellbore 50. BHA 70 includes an excitation sub 72, a downhole sensor package 74 including MWD sensors such as, for example, one or more magnetometers, gyroscopes, and/or one or more accelerometers for estimating an orientation and position of the BHA 70 within the subsurface region 1. Particularly, downhole sensor package 74 includes one or more electromagnetic ranging sensors for detecting electromagnetic subsurface signals. Additionally, BHA 70 includes a drill bit 76 for drilling into subsurface region 1 to extend the active wellbore 50 through subsurface region 1.

The excitation sub 72 of BHA 70 selectably produces an excitation signal or field (indicated by arrows 75 in FIG. 2) that extend from the excitation sub 72, travel through the subsurface region 1, and intercept the magnetic and/or nonmagnetic metallic materials 48 located within the openhole section 17 of the target wellbore 12. While in this exemplary embodiment excitation sub 72 is packaged as part of the BHA 70, in other embodiments, excitation sub 72 may be separate from the BHA 70. For example, the excitation sub 72 may instead be positioned along the drillstring 60 and spaced from the BHA 70. Additionally, in some embodiments, ranging system 10 may include a plurality of separate excitation subs 72 positioned at different locations in the active wellbore 50.

In some embodiments, excitation signal 75 comprises an electrical current that is induced in the subsurface region 1 by the excitation sub 72. For instance, the excitation sub 72 may create a short circuit with the subsurface region 1 to thereby inject or induce an electrical current in subsurface region 1. In other embodiments, excitation signal 75 may instead comprise an external magnetic field that travels through the subsurface region 1 and intercepts or is applied against magnetic and/or nonmagnetic metallic materials 48. For example, the excitation sub 72 may comprise a rotating magnet and the like for inducing the external magnetic field.

In response to intercepting or applying the excitation signal 75 to the magnetic and/or nonmagnetic metallic materials 48, the magnetic and/or nonmagnetic metallic materials 48 produce a corresponding electromagnetic subsurface signal that travels through the subsurface region 1 and is detectable by the downhole sensor package 74 of BHA 70. The electromagnetic subsurface signal may correspond to a disturbance in the Earth's natural magnetic field at the subsurface location of the magnetic and/or nonmagnetic metallic materials 48. In this manner, information representative of the subsurface location of the magnetic and/or nonmagnetic metallic materials, and hence the openhole section 17 of target wellbore 12 in which the magnetic and/or nonmagnetic metallic materials 48 are contained, may be embedded in the electromagnetic subsurface signal captured by the downhole sensor package 74. Ranging sensor data representative of these captured electromagnetic subsurface signals may be produced by and communicated from the downhole sensor package 74 to the surface computer system 90 of ranging system 10 via a variety of communication means. For instance, in some embodiments, drillstring 60 may include one or more signal conductors defining a signal pathway extending through the drillstring 60 to establish communication between the BHA 70 and the surface assembly 40 which may be in signal communication (e.g., wired or wireless signal communication) with the surface computer system 90. Alternatively, wireless communication means such as mud pulse telemetry and the like may be used to communicate between the BHA 70 and the surface assembly 40.

The surface computer system 90 ultimately receives the ranging sensor data from downhole sensor package 74 and estimates the subsurface location of the magnetic and/or nonmagnetic metallic materials 48 relative to the downhole sensor package 74 using the received ranging sensor data. In this manner, the surface computer system 90 may estimate or range the subsurface location of specifically the openhole section 17 of target wellbore 12 relative to the active wellbore 50. In some embodiments, the estimation of the subsurface location of openhole section 17 may be performed by surface computer system 90 in real-time or near real-time to provide an operator of ranging system 10 with up-to-date relative positioning information of openhole section 17 of target wellbore 12 and the active wellbore 50 as the active wellbore 50 is being actively drilled by the drill bit 76 of BHA 70.

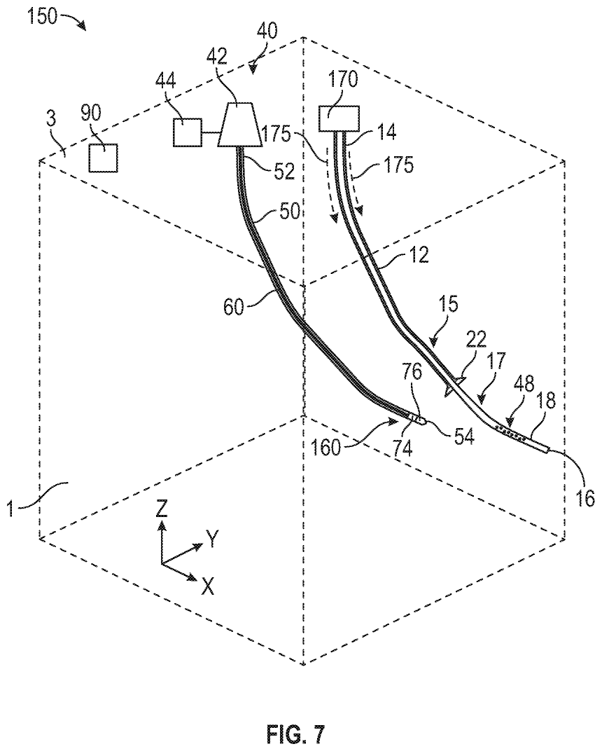

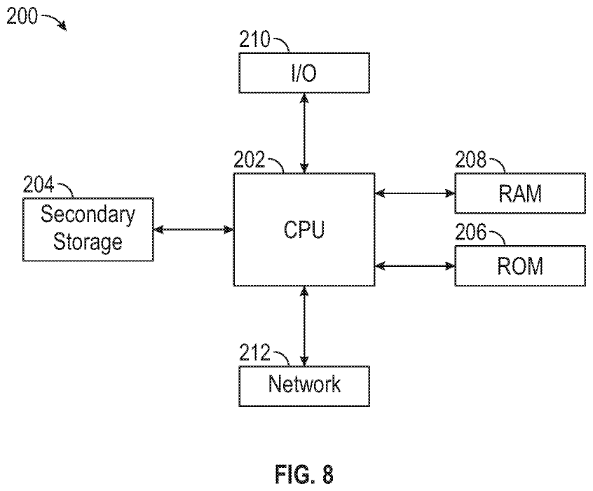

Referring to FIG. 7, another embodiment of a ranging system 150 is shown. Ranging system 150 includes features in common with ranging system 10 shown in FIGS. 1 and 2, and shared features are labeled similarly. Particularly, in this exemplary embodiment, ranging system 150 includes a BHA 160 positioned in the active wellbore 50 that does not include the excitation sub 72 of ranging system 10. Instead, ranging system 10 includes a surface excitation sub 170 located at the surface 3. Particularly, surface excitation sub 170 is positioned at the uphole end 14 of target wellbore 12. In this exemplary embodiment, surface excitation sub 170 selectably generates excitation signals (indicated by arrows 175 in FIG. 7) that travel from the surface 3, through the subsurface region 1 (e.g., along or near the target wellbore 12), and which intersect or are applied against the magnetic and/or nonmagnetic metallic materials 48 located in the openhole section 17 of target wellbore 12. While in this exemplary embodiment ranging system 150 only includes surface excitation sub 170, in other embodiments, ranging system 150 may include both surface excitation sub 170 and one or more downhole excitation subs 72 positioned in the active wellbore 50.

Referring now to FIG. 7, an embodiment of a computer system 200 is shown suitable for implementing one or more features disclosed herein. As an example, computer system 200 may be used to execute at least some of the features of ranging systems 10 and 150 shown in FIGS. 1, 2, and 7, such as surface computer system 90 thereof. The computer system 200 of FIG. 5 generally includes a processor 202 (which may be referred to as a central processor unit or CPU) that is in communication with memory devices including secondary storage 204, read only memory (ROM) 206, random access memory (RAM) 208, input/output (I/O) devices 210, and network connectivity devices 212. Processor 202 may be implemented as one or more CPU and/or graphics processing unit (GPU) chips. It is understood that by programming and/or loading executable instructions onto the computer system 200, at least one of the CPU 202, the RAM 208, and the ROM 206 are changed, transforming the computer system 200 in part into a particular machine or apparatus having the novel functionality taught by the present disclosure.

Additionally, after the system 200 is turned on or booted, the CPU 202 may execute a computer program or application. For example, the CPU 202 may execute software or firmware stored in ROM 206 or stored in RAM 208. In some cases, on boot and/or when the application is initiated, the CPU 202 may copy the application or portions of the application from the secondary storage 204 to the RAM 208 or to memory space within the CPU 202 itself, and the CPU 202 may then execute instructions that the application is comprised of. In some cases, the CPU 202 may copy the application or portions of the application from memory accessed via the network connectivity devices 212 or via the I/O devices 210 to the RAM 208 or to memory space within the CPU 202, and the CPU 202 may then execute instructions that the application is comprised of. During execution, an application may load instructions into the CPU 202, for example load some of the instructions of the application into a cache of the CPU 202. In some contexts, an application that is executed may be said to configure the CPU 202 to do something, e.g., to configure the CPU 202 to perform the function or functions promoted by the subject application. When the CPU 202 is configured in this way by the application, the CPU 202 becomes a specific purpose computer or a specific purpose machine.

Secondary storage 204 may be used to store programs which are loaded into RAM 208 when such programs are selected for execution. The ROM 206 is used to store instructions and perhaps data which are read during program execution. ROM 206 is a non-volatile memory device which typically has a small memory capacity relative to the larger memory capacity of secondary storage 204. The secondary storage 204, the RAM 208, and/or the ROM 206 may be referred to in some contexts as computer readable storage media and/or non-transitory computer readable media. I/O devices 210 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 212 may take the form of modems, modem banks, Ethernet cards, universal serial bus (USB) interface cards, wireless local area network (WLAN) cards, radio transceiver cards, and/or other well-known network devices. Network connectivity devices 212 may provide wired communication links and/or wireless communication links. These network connectivity devices 212 may enable the processor 202 to communicate with the Internet or one or more intranets. With such a network connection, it is contemplated that the processor 202 might receive information from the network or might output information to the network. Such information, which may include data or instructions to be executed using processor 202 for example, may be received from and outputted to the network, for example, in the form of a computer data baseband signal or signal embodied in a carrier wave.

The processor 202 executes instructions, codes, computer programs, scripts which it accesses from hard disk, floppy disk, optical disk, flash drive, ROM 206, RAM 208, or the network connectivity devices 212. While only one processor 202 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 204, for example, hard drives, floppy disks, optical disks, and/or other device, the ROM 206, and/or the RAM 208 may be referred to in some contexts as non-transitory instructions and/or non-transitory information.

In an embodiment, the computer system 200 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

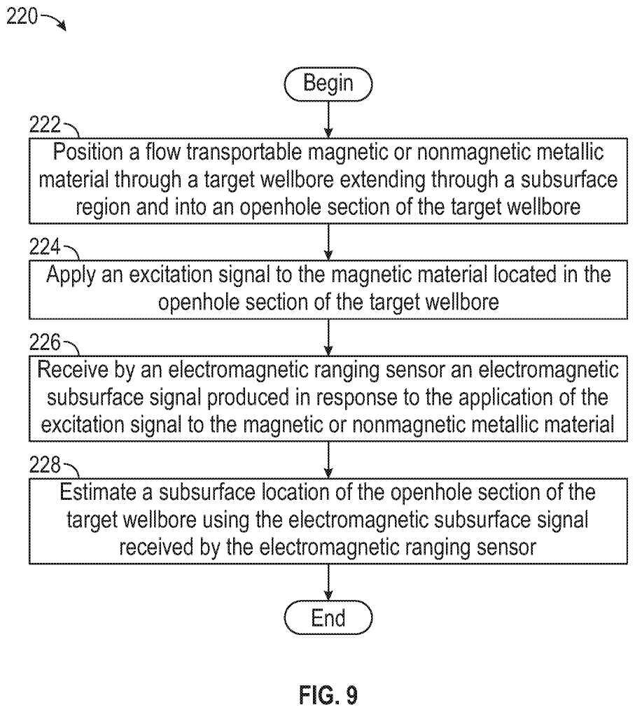

Referring to FIG. 9, an exemplary method 220 for estimating a subsurface location of a target wellbore (e.g., target wellbore 12 shown in FIGS. 1-7). Initially, at block 222, method 220 includes positioning a flow transportable magnetic and/or nonmagnetic metallic material (e.g., magnetic and/or nonmagnetic metallic materials 48 shown in FIGS. 1, 2, and 7, magnetic and/or nonmagnetic metallic materials 100, 110, 120, and 130 shown in FIGS. 3-6) through a target wellbore extending through a subsurface region (e.g., subsurface region 1 shown in FIGS. 1-7) and into an openhole section (e.g., openhole section 17 of target wellbore 12 shown in FIGS. 1-7) of the target wellbore.

At block 224, method 220 includes applying an excitation signal (e.g., excitation signals 75 shown in FIG. 2, excitation signals 175 shown in FIG. 7) to the magnetic and/or nonmagnetic metallic material located in the openhole section of the target wellbore. At block 226, method 220 includes receiving by an electromagnetic ranging sensor (e.g., downhole sensor package 74 shown in FIGS. 1, 2, and 7) an electromagnetic subsurface signal produced in response to the application of the excitation signal to the magnetic and/or nonmagnetic metallic material. At block 228, method 220 includes estimating a subsurface location of the openhole section of the target wellbore using the electromagnetic subsurface signal received by the electromagnetic ranging sensor. The electromagnetic ranging sensor may comprise, for example, a magnetic ranging sensor, an electrical resistivity sensor, and the like.

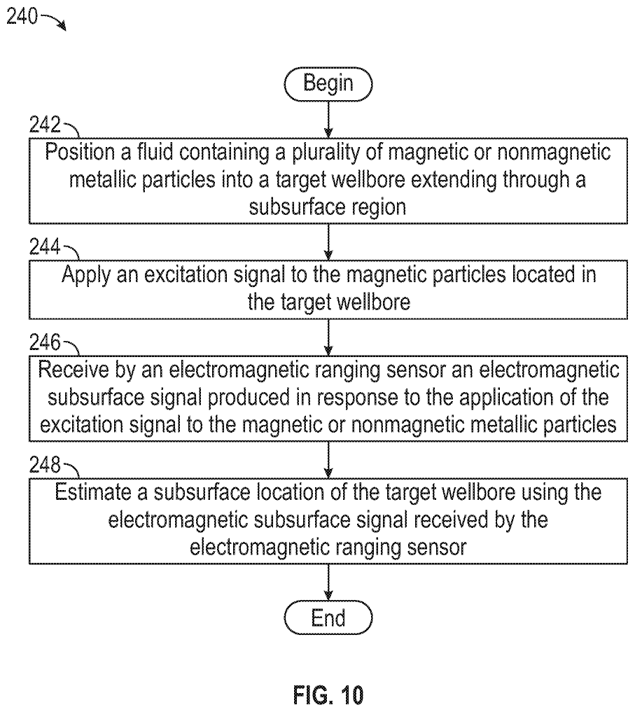

Referring to FIG. 10, another exemplary method 240 for estimating a subsurface location of a target wellbore (e.g., target wellbore 12 shown in FIGS. 1-7). Initially, at block 242, method 240 includes positioning a fluid containing a plurality of magnetic particles (e.g., magnetic and/or nonmagnetic metallic materials 48 shown in FIGS. 1, 2, and 7, magnetic and/or nonmagnetic metallic materials 100, 110, and 120 shown in FIGS. 3-5) into a target wellbore extending through a subsurface region (e.g., subsurface region 1 shown in FIGS. 1-7).

At block 244, method 240 includes applying an excitation signal (e.g., excitation signals 75 shown in FIG. 2, excitation signals 175 shown in FIG. 7) to the magnetic particles located in the target wellbore. At block 246, method 240 includes receiving by an electromagnetic ranging sensor (e.g., downhole sensor package 74 shown in FIGS. 1, 2, and 7) an electromagnetic subsurface signal produced in response to the application of the excitation signal to the magnetic particles. At block 248, method 240 includes estimating a subsurface location of the target wellbore using the electromagnetic subsurface signal received by the electromagnetic ranging sensor. The electromagnetic ranging sensor may comprise, for example, a magnetic ranging sensor, an electrical resistivity sensor, and the like.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps but rather are used to simplify subsequent reference to such steps.

What is claimed is:

1. A method for estimating a subsurface location of a target wellbore, the method comprising:
(a) positioning a flow transportable magnetic or nonmagnetic metallic material through a target wellbore extending through a subsurface region and into an openhole section of the target wellbore;
(b) applying an excitation signal to the magnetic or nonmagnetic metallic material located in the openhole section of the target wellbore;
(c) receiving by an electromagnetic ranging sensor an electromagnetic subsurface signal produced in response to an application of the excitation signal to the magnetic or nonmagnetic metallic material; and
(d) estimating a subsurface location of the openhole section of the target wellbore using the electromagnetic subsurface signal received by the electromagnetic ranging sensor.

2. The method of claim 1, wherein the magnetic or nonmagnetic metallic material comprises at least one of a magnetic plug and a magnetic packer.

3. The method of claim 1, wherein the magnetic or nonmagnetic metallic material comprises a ferrofluid.

4. The method of claim 1, wherein the magnetic or nonmagnetic metallic material comprises a magneto-rheological (MR) fluid.

5. The method of claim 4, wherein the MR fluid comprises a carrier liquid and a plurality of magnetic particles settled from the carrier liquid and lining a sidewall and/or a toe end of the target wellbore.

6. The method of claim 1, wherein the magnetic or nonmagnetic metallic material comprises a drilling fluid including a plurality of magnetic or nonmagnetic metallic particles.

7. The method of claim 1, wherein the magnetic or nonmagnetic metallic material comprises a filter cake at least partially lining a sidewall of the target wellbore, the filter cake comprising a plurality of magnetic or nonmagnetic metallic particles.

8. The method of claim 1, wherein (b) comprises inducing an electrical current and/or a radio frequency energy in the subsurface region.

9. The method of claim 1, wherein (b) comprises inducing an external magnetic field in the subsurface region.

10. The method of claim 1, wherein (b) comprises inducing the excitation signal by an excitation sub located in an active wellbore extending through the subsurface region that is different from the target wellbore.

11. The method of claim 1, wherein (b) comprises inducing the excitation signal by an excitation sub located at a surface of the target wellbore.

12. The method of claim 1, wherein the electromagnetic subsurface signal comprises an electrical resistivity subsurface signal.

13. A method for estimating a subsurface location of a target wellbore, the method comprising:
(a) positioning a fluid containing a plurality of magnetic or nonmagnetic metallic particles into a target wellbore extending through a subsurface region;
(b) applying an excitation signal to the magnetic or nonmagnetic metallic particles located in the target wellbore;
(c) receiving by an electromagnetic ranging sensor an electromagnetic subsurface signal produced in response to an application of the excitation signal to the magnetic or nonmagnetic metallic particles; and
(d) estimating a subsurface location of the target wellbore using the electromagnetic subsurface signal received by the electromagnetic ranging sensor.

14. The method of claim 13, wherein the fluid comprises a ferrofluid.

15. The method of claim 13, wherein the fluid comprises a magneto-rheological (MR) fluid.

16. The method of claim 15, wherein a plurality of magnetic particles of the MR fluid form a continuous, electrically conductive path lining a sidewall and/or a toe end of the target wellbore.

17. The method of claim 13, wherein the fluid forms a filter cake at least partially lining a sidewall of the target wellbore, the filter cake comprising the magnetic or nonmagnetic metallic particles.

18. The method of claim 13, wherein (b) comprises inducing the excitation signal by an excitation sub located in an active wellbore extending through the subsurface region that is different from the target wellbore.

19. The method of claim 13, wherein (b) comprises inducing the excitation signal by an excitation sub located at a surface of the target wellbore.

20. The method of claim 13, wherein the fluid comprises a plurality of magnetic particles.

21. The method of claim 13, wherein the magnetic or nonmagnetic metallic particles each have a diameter that is equal to or less than 10 millimeters.

22. The method of claim 13, wherein the magnetic or nonmagnetic metallic particles each have a diameter that is equal to or less than 100 nanometers.

23. A system for estimating a subsurface location of a target wellbore, the system comprising:
a target wellbore extending through a subsurface region and which comprises a cased section and an openhole section;
a flow transportable magnetic or nonmagnetic metallic material located in the openhole section of the target wellbore;
an active wellbore extending through the subsurface region;
an excitation sub configured to apply an excitation signal to the magnetic or nonmagnetic metallic material located in the openhole section of the target wellbore;
an electromagnetic ranging sensor positioned in the active wellbore and which is configured to receive an electromagnetic subsurface signal produced in response to an application of the excitation signal to the magnetic or nonmagnetic metallic material; and
a computer system comprising one or more processors and a storage device coupled to the one or more processors, the storage device configured to store instructions that, when executed by the one or more processors, configure the one or more processors to:
estimate a subsurface location of the openhole section of the target wellbore using the electromagnetic subsurface signal received by the electromagnetic ranging sensor.
